(19) United States
(12) Patent Application Publication
(10) Pub. No.: US 2009/0288066 A1
(43) Pub. Date: Nov. 19, 2009

(54) EDITING APPARATUS AND METHOD FOR TEST DRIVEN DEVELOPMENT

(75) Inventors: Yang Jae Jeong, Daejeon (KR); Seok Jin Yoon, Daejeon (KR); Gyu Sang Shin, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/508,187

(22) Filed: Jul. 23, 2009

(30) Foreign Application Priority Data
Feb. 12, 2008 (KR) 10-2008-0120903
Mar. 27, 2009 (KR) 10-2009-0026292

(51) Int. Cl. G06F 9/44

(52) U.S. Cl. 717/110; 717/104

(57) ABSTRACT

An editing apparatus for Test Driven Development (TDD) includes: a design model manager for managing a design model; a test code manager for managing test code; an implementation code manager for managing implementation code; and a TDD synchronization manager, as the design model or the test code is altered, for altering the test code or the design model in synchronization with the design model or the test code, and selectively altering the implementation code.

### CROSS-REFERENCE(S) TO RELATED APPLICATION(S)

The present invention claims priority of Korean Patent Application No. 10-2008-0120903, filed on Dec. 2, 2008, and No. 10-2009-0026292, filed on Mar. 27, 2009, which are incorporated herein by reference.

### FIELD OF THE INVENTION

The present invention relates to an editing apparatus and method for software development, more specifically, to an editing apparatus and method for test-driven development which support xUnit for improving speed of development and reliability of results of the development at the time of developing software.

### BACKGROUND OF THE INVENTION

Since it is not easy to completely design complicated software in just one time, a method of designing software using UML (Unified Modeling Language) and then conducting tests has been widely used.

In addition, continuous changes in users' requirements make it more difficult to complete software design. Since insufficient software design and a system implemented by such software include considerable errors, a lot of time and effort are required for tests after the software development. Due to indefiniteness of the design, a test process is based on presumption so that it proceeds through a lot of trial and error.

Various methods for solving these problems have been developed, and a test framework called ‘xUnit’ is increasingly being used.

xUnit is a device to enable Test Driven Development (hereinafter referred to as ‘TDD’) by which tests that have been conducted at the final stage to date may be conducted before the implementation of software.

In such a TDD method, before the implementation of software, test code used for tests is created in advance, and is then applied to the software currently being developed. In this case, since the test code also tests parts of the software which have not been implemented yet, errors may occur. However, such an error may be removed by implementing codes corresponding to the test code in which errors occurred. This procedure for removing the error may be regarded as an implementation procedure.

When details of software design which is apt to be vague are established clearly and then are represented into codes, these codes are considered as test code. ‘jUnit’, initially used for the development of Java, was extended later to a form that can be used by various program languages, and such an extended form is called ‘xUnit’. Further, functions of making test code into assets for various professional fields have been added.

It is well known that software development methods of performing TDD using such xUnit make great profit.

However, in the development of software using conventional xUnit, test code and implementation code are separately created, as shown in FIG. 1. Accordingly, the conventional xUnit has problems in that, since two types of codes must be managed, creation and modification of the codes are inconvenient so that it lays more burden on a developer. Thus, many developers do not use xUnit yet.

In addition, the conventional xUnit does not have functions related to design technology, which is also necessary, enabling more parts to be tested at one time by abstractly expressing software.

### SUMMARY OF THE INVENTION

In view of the above, the present invention provides an editing apparatus and method for TDD, which can not only alter a design model but also selectively and automatically alter implementation code, depending on the modification of test code when xUnit is implemented.

In accordance with one aspect of the present invention, there is provided an editing apparatus for Test Driven Development (TDD), including:

a design model manager for managing a design model;

a test code manager for managing test code;

an implementation code manager for managing implementation code; and

a TDD synchronization manager, as the design model or the test code is altered, for altering the test code or the design model in synchronization with the design model or the test code, and selectively altering the implementation code.

In accordance with another aspect of the present invention, there is provided an editing method for Test Driven Development (TDD) including an apparatus of displaying a design model, test code and implementation code on different frames, respectively, wherein code editing method of the apparatus includes:

when the design model or the test code is altered, generating information about the alteration of the design model or the test code;

altering the test code or the design model using the generated alteration information;

checking whether to alter the implementation code according to the generated alteration information; and

altering the implementation code on the basis of the checking result.

### BRIEF DESCRIPTION OF THE DRAWINGS

The above features of the present invention will become apparent from the following description of embodiments given in conjunction with the accompanying drawings, in which:

FIG. 1 is a diagram showing a conventional software development process;

FIG. 2 is a diagram for explaining the basic concept of an editing apparatus for Test Driven Development (TDD) in accordance with the present invention;

FIG. 3 is a block diagram showing an editing apparatus for TDD in accordance with the present invention;

FIG. 4 is a diagram showing an editing window for developing a program with reference to a design model;

FIG. 5 is a diagram showing the entire window of an editing apparatus in accordance with the present invention; and

FIG. 6 is a flowchart illustrating a process of altering codes using an editing apparatus for TDD in accordance with the present invention.

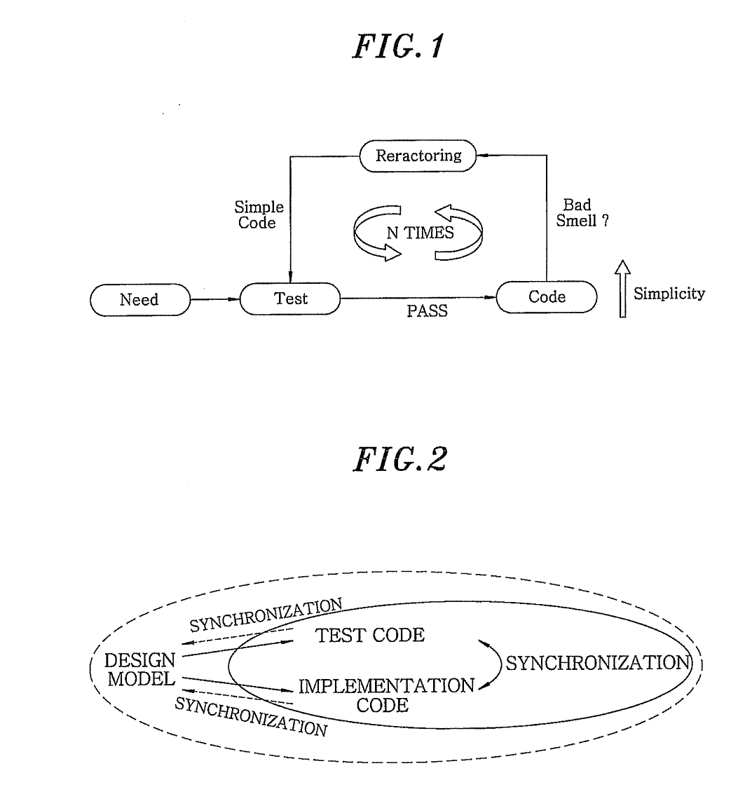

### DETAILED DESCRIPTION OF THE PREFERRED EMBODIMENTS

Hereinafter, embodiments of the present invention will be described in detail with reference to the accompanying drawings. In the following description of the present invention, if detailed descriptions of related well-known constructions or functions are determined to make the gist of the present invention unclear, the detailed descriptions will be omitted.

FIG. 2 is a diagram showing the basic concept of an editing apparatus for Test-Driven Development (TDD) supporting xUnit in accordance with the present invention.

As shown in FIG. 2, the editing apparatus for TDD individually synchronizes a design model with test code and implementation code, and synchronizes the test code with the implementation code. That is, as the test code is altered, the design model is altered and the implementation code is selectively altered through the synchronization therebetween. Further, as the implementation code or the test code is altered, the design model is altered through the synchronization therebetween.

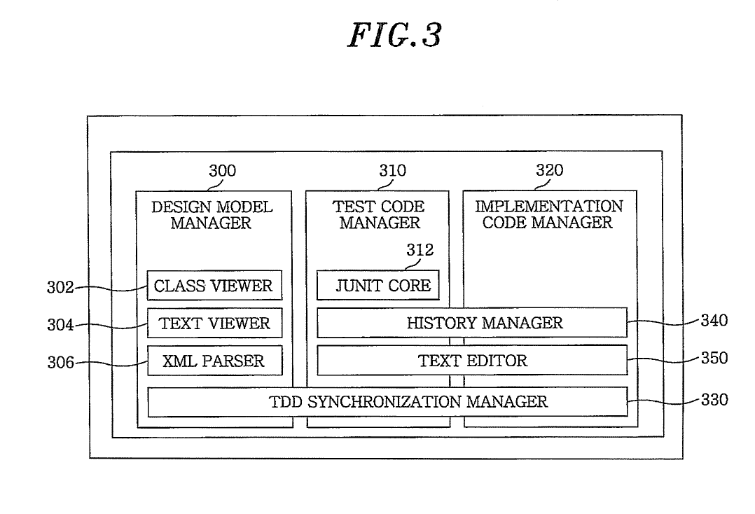

FIG. 3 is a block diagram showing an editing apparatus for TDD supporting xUnit in accordance with the present invention.

As shown in FIG. 3, the editing apparatus for TDD includes a design model manager 300, a test code manager 310, and an implementation code manager 320. The design model manager 300 includes a class viewer 302, a text viewer 304 and an XML (extensible markup language) parser 306. The test code manager 310 includes a jUnit core 312. The design model manager 300, the test code manager 310 and the implementation code manager 320 are synchronized with one another by a TDD synchronization manager 330.

Further, the test code manager 310 and the implementation code manager 320 include in common a history manager 340 and a text editor 350, and may edit test code and implementation code, respectively, using the text editor 350.

The design model manager 300 parses an XML file using the XML parser 306, displays the parsed XML file through the text viewer 304, or displays the parsed XML file in the form of a class diagram using the class viewer 302.

As a design model is altered, the design model manager 300 generates information on the alteration of the design model. The design model alteration information is provided both to the test code manager 310 and to the implementation code manager 320 by the TDD synchronization manager 330. The test code manager 310 and the implementation code manager 320 display a warning message indicating that the test code and the implementation code corresponding to the received design model alteration information is required to be altered. At this time, the test code manager 310 automatically alters the test code on the basis of the design model alteration information, and the implementation code manager 320 stores the design model alteration information in a storage medium such as memory, and thereafter selectively alters the implementation code by request of a developer.

As the test code is altered, the test code manager 310 generates information on the alteration of the test code, and provides the test code alteration information both to the design model manager 300 and to the implementation code manager 320 using the TDD synchronization manager 330. The design model manager 300 and the implementation code manager 320 display a warning message indicating that the design model and the implementation code corresponding to the received test code alteration information is required to be altered. At this time, the design model manager 300 automatically alters the design model on the basis of the test code alteration information, and the implementation code manager 320 stores the test code alteration information in a storage medium such as memory, and thereafter selectively alters the implementation code by request of the developer.

As the implementation code is altered, the implementation code manager 320 generates information on alteration of the implementation code, and provides the implementation code alteration information both to the design model manager 300 and to the test code manager 310 using the TDD synchronization manager 330. The design model manager 300 and the test code manager 310 display a warning message indicating that the design model and the test code corresponding to the received implementation code alteration information is required to be altered. At this time, the design model manager 300 and the test code manager 310 automatically alter the design model and the test code, respectively, on the basis of the implementation code alteration information.

Meanwhile, the implementation code manager 310 provides a selection interface capable of selecting whether to automatically alter the implementation code using alteration information received when the test code or the design model is altered, and applies the alteration information to the implementation code through the operation of the selection interface.

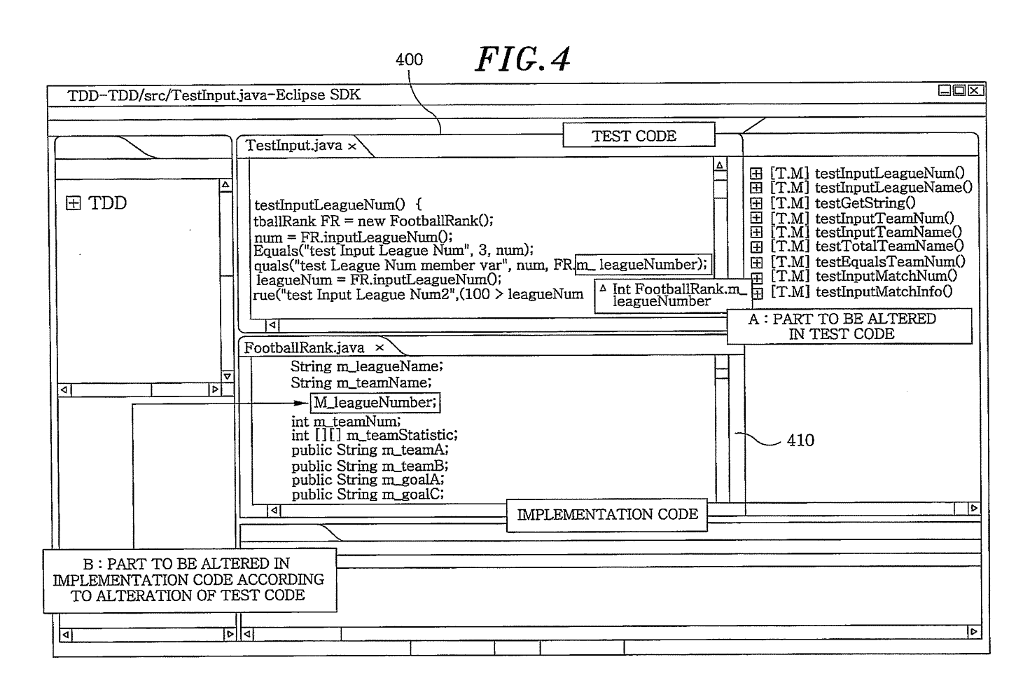

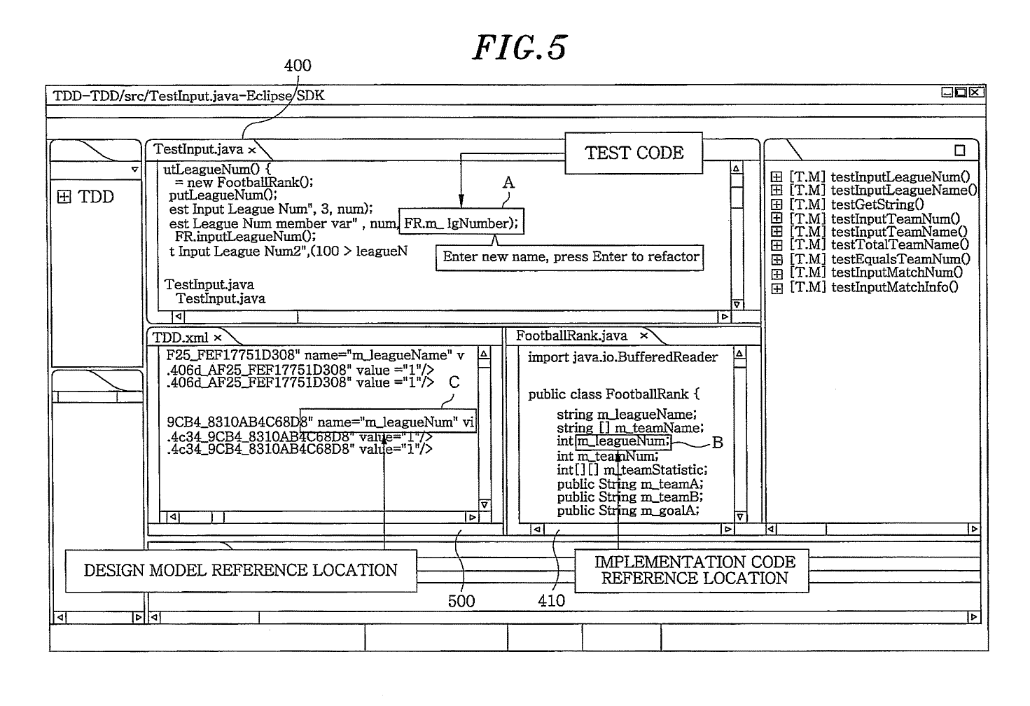

A process of performing synchronization through the operation between the implementation code manager 320 and the test code manager 310 in the present editing apparatus for TDD will be described with reference to FIG. 4.

As shown in FIG. 4, the editing apparatus for TDD in accordance with the present invention provides a first editing frame 400 on which test code is displayed, and a second editing frame 410 on which implementation code is displayed.

When a program developer alters a part A in test code on the first editing frame 400 using the text editor 350 of the test code manager 310 while developing software, the test code manager 310 notifies the implementation code manager 320 of the alteration information of the part A in the test code. Then, the implementation code manager 320 may highlight a part B in implementation code on the second editing frame 410, corresponding to the altered part A, to inform the program developer that alteration of the part B is required, or may alter the part B based on the alteration information of the part A. Here, notifying the second editing frame 410 of the alteration of the test code on the first editing frame 400 is performed through the TDD synchronization manager 330. Specifically, when the part A of the first editing frame 400 is altered, the alteration information thereof is provided to the implementation code manager 320 through the TDD synchronization manager 330. Then, the implementation code manager 320 notifies the developer, in form of a warning message, that alteration of the part B in the implementation code corresponding to the part A in the test code is required, or alters the part B based on the alteration information of the part A.

FIG. 5 is a diagram for showing a process of conducting software development with reference to a design model in accordance with the present invention. In FIG. 5, a third editing frame 500 on which design information is displayed is further included in addition to the editing frames of FIG. 4. The design information is that an XML file parsed by the XML parser 306 is displayed. Here, the XML file may be displayed in a text form on the third editing frame 500 or, in form of a class diagram on the third editing frame 500 by using the class viewer 302, depending on a user's choice.

As shown in FIG. 5, when a software developer alters a part A in test code on the first editing frame 400, the test code manager 310 provides alteration information of the part A both to the implementation code manager 320 and to the design model manager 300, through the TDD synchronization manager 330. Then, the implementation code manager 320 automatically alters a part B in implementation code, which is a part corresponding to the part A, on the second editing frame 410. The design model manager 300 automatically alters a part C in design model, which is a part corresponding to the part A, on the third editing frame 500.

In the above example, the case that the test code is altered has been described, but, even when the implementation code or the design model is altered, the same process is performed. That is, when the implementation code or the design model is altered, the alteration information is provided to other managers through the TDD synchronization manager 330, and the corresponding managers notified of the alteration information may automatically alter corresponding parts therein.

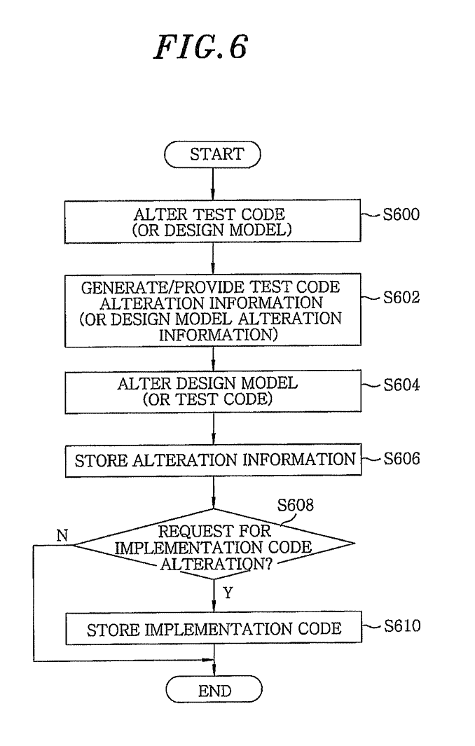

FIG. 6 is a flowchart showing a process for altering code using the editing apparatus for TDD in accordance with the present invention.

Referring to FIG. 6, a developer alters test code (or a design model) displayed on the first editing frame 400 (or the third editing frame 500) in the interface window as shown in FIG. 5 at step S600.

According to the alteration, the test code manager 310 (or the design model manager 300) generates test code alteration information (or design model alteration information), and then provides the test code alteration information (or design model alteration information) to the design model manager 300 (or the test code manager 310) and the implementation code manager 320, through the TDD synchronization manager 330 at step S602.

The design model manager 300 (or the test code manager 310) automatically alters design model (or test code) in response to the alteration information received through the TDD synchronization manager 330 at step S604.

The implementation code manager 320 stores the received alteration information in a storage medium at step S606, and thereafter checks, using selection interface, whether to alter implementation code in response to the alteration information at step S608.

According to the checking result, when there is a request for altering the implementation code, the implementation code manager 320 alters the implementation code corresponding to the received alteration information at step S610.

Since such alteration information of the test code and the design model is stored, when the implementation code needs to be altered, it can be performed by a user just selecting automatic alteration. Therefore, the present invention is advantageous in that a burden on a developer becomes reduced, and thus TDD can be easily applied, even though the test code is separately created.

Further, the present invention is advantageous in that a window on which a design model as well as test code and implementation code can be viewed together is provided, and in that the design model and the test code can be automatically synchronized with each other, thereby enabling the design model to be used in TDD.

While the invention has been shown and described with respect to the embodiments, it will be understood by those skilled in the art that various changes and modifications may be made without departing from the scope of the invention as defined in the following claims.

What is claimed is:

1. An editing apparatus for Test Driven Development (TDD), comprising:
a design model manager for managing a design model;
a test code manager for managing test code;
an implementation code manager for managing implementation code; and
a TDD synchronization manager, as the design model or the test code is altered, for altering the test code or the design model in synchronization with the design model or the test code, and selectively altering the implementation code.

2. The editing apparatus of claim 1, wherein the design model manager, as the design model is altered, generates information about the alteration of the design model, and then provides the design model alteration information to the test code manager and to the implementation code manager.

3. The editing apparatus of claim 2, wherein the test code manager and the implementation code manager provide a warning message indicating that a part of the test code and a part of the implementation code, corresponding to the design model alteration information, are required to be altered, when having received the design model alteration information.

4. The editing apparatus of claim 1, wherein the test code manager, as the test code is altered, generates information about the alteration of the test code, and then provides the test code alteration information to the design model manager and to the implementation code manager.

5. The editing apparatus of claim 4, wherein the design model manager and the implementation code manager provide a warning message indicating that a part of the design model and a part of the implementation code, corresponding to the test code alteration information, are required to be altered when having received the test code alteration information.

6. The editing apparatus of claim 1, wherein the implementation code manager, as the implementation code is altered, generates information about the alteration of the implementation code, and provides the implementation code alteration information to the test code manager and to the design model manager.

7. The editing apparatus of claim 6, wherein the test code manager and the design model manager provide a warning message indicating that a part of the test code and a part of the design model, corresponding to the implementation code alteration information, are required to be altered when having received the implementation code alteration information.

8. The editing apparatus of claim 1, wherein the implementation code manager provides a selection interface capable of selecting whether to automatically alter the implementation code, when the test code or the design model is altered.

9. The editing apparatus of claim 8, wherein the implementation code manager stores information about the alteration of the test code or the design model, and according to operation of the selection interface, alters the implementation code using the stored information.

10. An editing method for Test Driven Development (TDD), comprising an apparatus of displaying a design model, test code and implementation code on different frames, respectively, wherein code editing method of the apparatus includes:
when the design model or the test code is altered, generating information about the alteration of the design model or the test code;
altering the test code or the design model using the generated alteration information;
checking whether to alter the implementation code according to the generated alteration information; and
altering the implementation code on the basis of the checking result.

11. The editing method of claim 10, wherein said checking whether to alter the implementation code includes storing the generated alteration information and checking whether to alter the implementation code according to the stored alteration information.
